(19) United States
(12) Patent Application Publication
(10) Pub. No.: US 2020/0082080 A1
(43) Pub. Date: Mar. 12, 2020

(54) BINARY RISK EVALUATION

(71) Applicant: BlackBerry Limited, Waterloo (CA)

(72) Inventors: Adam John BOULTON, Wirral (GB); Benjamin John GODWOOD, Chipping Norton (GB)

(21) Appl. No.: 16/129,306

(22) Filed: Sep. 12, 2018

(51) Int. Cl. G06F 21/56; G06F 8/41; G06F 8/77

(52) U.S. Cl. CPC G06F 21/565; G06F 8/77; G06F 8/433

(57) ABSTRACT

A computer includes a memory and a processor programmed to execute instructions stored in the memory. The instructions include processing a binary file to determine a security risk associated with the binary file. Processing the binary file includes determining a characteristic from metadata of the binary file. The security risk associated with the binary file is based at least in part on the characteristic of the binary file.

### BACKGROUND

A binary file is a type of computer file in a computer-readable format. Rather than store data as text, a binary file stores data as a string of binary digits, such as a sequence of bytes. Computer code, in human-readable format, can be compiled into a binary file so the computer code can be executed by the computer. While not typically stored in a human-readable format, the data in a binary file can be represented as text in formats such as hexadecimal, decimal, binary, ASCII, etc.

### BRIEF DESCRIPTION OF THE DRAWINGS

FIG. 1 illustrates an example computer programmed to evaluate binary files for security risks.

FIG. 2 is a flowchart of an example process that may be executed by the computer to evaluate binary files for security risk.

### DETAILED DESCRIPTION

Binary files can be analyzed to determine if the binary file is likely to contain malicious computer code or computer code that makes the computer vulnerable to security risks. For certain software systems, the volume and size of software components can make it difficult to quickly navigate and prioritize where the greatest risks are likely to reside. The system described below, however, is able to more quickly assess a binary component for high risk areas of implementation.

As explained in greater detail below, binary components can be analyzed for code size, data size, the number of insecure application programming interfaces (APIs), the number of conditional statements, and the cyclomatic complexity. For example, a large code size has a larger attack surface. For data size, the number of constants and variables referenced by a function can indicate how much data processing will take place. The number of insecure APIs can indicate the risk for vulnerability based on, e.g., the number of processing strings, memory usage, and inputs/outputs used by the insecure API. Insight into the number of conditions or decisions that are being made can also indicate the security risk. Moreover, because cyclomatic complexity is a quantitative software metric that can be used to indicate the complexity of a program based on, e.g., the number of linearly independent paths through a program's source code, cyclomatic complexity can represent the likelihood of a security vulnerability in a binary. By evaluating these, and possibly other, factors, metrics representing the vulnerability of a binary file can be output.

An example computer that can predict vulnerabilities in binary files includes a memory and a processor programmed to execute instructions stored in the memory. The instructions include processing a binary file to determine a security risk associated with the binary file. Processing the binary file includes determining a characteristic from metadata of the binary file. The security risk associated with the binary file is based at least in part on the characteristic of the binary file.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

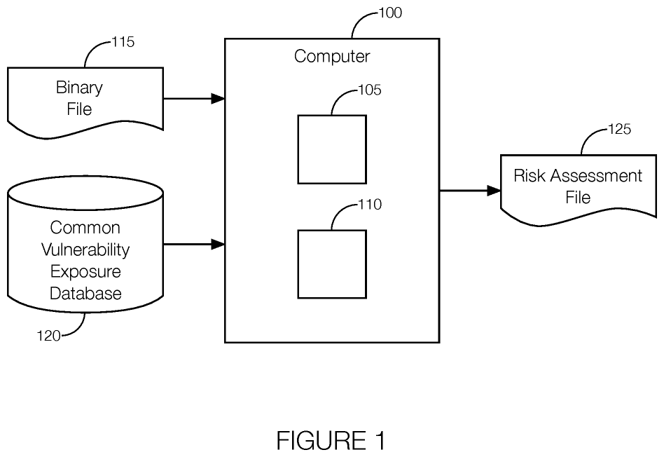

As illustrated in FIG. 1, a computer 100 includes a memory 105 and a processor 110. The computer 100 receives a binary file 115 and data from a common vulnerability exposure (CVE) database 120, processes the binary file 115 in accordance with the data stored in the CVE database 120, and outputs a risk assessment file 125 including metrics representing the vulnerability of the binary file 115. The metrics in the risk assessment file 125 output by the computer 100 represent the security risk posed by the binary file 115.

The memory 105 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory 105 may store instructions executable by the processor 110 and data such as binary files 115, the CVE database 120, and the risk assessment file 125. The binary file 115 (or “binary”) is a computer-readable file including data. The binary file 115 is created by compiling human-readable computer code, such as computer code written in programming languages such as C, C++, Java, etc., in a computer-readable format. The CVE database 120 is a software file including electronic data representing known security vulnerabilities associated with using certain APIs, software libraries, etc. The risk assessment file 125 is a software file that includes data representing metrics associated with the security risk posed by the binary file 115.

The processor 110 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The processor 110 is programmed to access data stored in the memory 105, process the data, and generate data that can be stored in the memory 105, displayed on a computer monitor, transmitted to another computer or mobile device, etc.

The processor 110 is programmed to access metadata, stored in the memory 105, about the binary file 115. The metadata may include characteristics of the binary file 115 such as the size of the binary file 115, the amount of data processing involved with the binary file 115, the number of insecure APIs used in the binary file 115, the number of conditional statements in the code represented by the binary file 115, the cyclomatic complexity of the binary file 115, etc. In some instances, the processor 110 may be programmed to determine one or more of the characteristics by processing the binary file 115 and storing the characteristics as data or metadata in the memory 105.

The processor 110 is programmed to generate the risk assessment file 125 based on the characteristics of the binary file 115. For example, the processor 110 may be programmed to determine that a binary file 115 with a code size above a predetermined threshold is more likely to have security vulnerabilities than a binary file 115 with a code size below the predetermined threshold since, e.g., a large code size presents a larger attack surface area. The processor 110 may be programmed to consider any number of predetermined thresholds and determine the security vulnerability based on the code size relative to any one or more of the predetermined thresholds.

The processor 110 may be programmed to determine that the number of constants and variables referenced by a function can indicate how much data processing will take place. More data processing may suggest greater vulnerability. Thus, the processor 110 may be programmed to compare the number of constants and variables called by a function to one or more predetermined thresholds. The processor 110 may be programmed to determine the security risk, at least in part, based on whether the number of constants and variables exceeds one or more of the predetermined thresholds.

The processor 110 may be programmed to determine the number of insecure APIs appearing in the binary file 115. The number of insecure APIs can indicate the risk for vulnerability based on, e.g., the number of processing strings, memory usage, and inputs/outputs used by the insecure API. The processor 110 may be programmed to compare the number of processing strings, the amount of memory usage, the number of inputs/outputs, etc., to any number of predetermined thresholds. The processor 110 may be programmed to consider the number of processing strings, the amount of memory usage, the number of inputs/outputs, etc., relative to the predetermined thresholds when assessing the security risk. Further, the processor 110 may be programmed to consult the CVE database 120 to determine, e.g., known security issues associated with the APIs used in the code represented by the binary file 115.

The processor 110 may be programmed to count the number of conditions or decisions that are being made by the code represented by the binary file 115. The processor 110 may be programmed to determine that more conditions and decisions appearing in the code indicates an increased security risk. Thus, the processor 110 may be programmed to compare the number of conditions or decisions being made to any number of predetermined thresholds. The processor 110 may be further programmed to consider the number of conditions or decisions being made relative to the predetermined thresholds when determining the security risk of the binary file 115.

The processor 110 may be programmed to determine the cyclomatic complexity of the binary file 115. The cyclomatic complexity is a quantitative software metric that represents the complexity of the binary file 115 based on, e.g., the number of linearly independent paths through a program's source code. The processor 110 may be programmed to compare the cyclomatic complexity to a predetermined threshold and determine the security vulnerability of the binary file 115 based at least in part on the cyclomatic complexity relative to the predetermined threshold. For instance, the processor 110 may be programmed to determine that the binary file 115 is exposed to a higher security risk if, e.g., the cyclomatic complexity exceeds the predetermined threshold.

For purposes of simplicity, the processor 110 is described as being programmed to compare each characteristic to one or more predetermined threshold. In practice, the processor 110 may be programmed to compare each characteristic to any number of predetermined thresholds. Further, in some instances, one or more of the predetermined thresholds may be variable. For example, the predetermined threshold may be another characteristic, a function of another characteristic, or some other value.

The processor 110 may be programmed to generate the risk assessment file 125 according to the security risk posed by the binary file 115 in view of the characteristics, the data from the CVE database 120, or a combination of both. That is, the processor 110 may determine metrics defining how vulnerable the binary file 115 is to a security threat. The processor 110 may generate the risk assessment file 125 to reflect the metrics, the vulnerability of the binary file 115 to a security threat, or both. The processor 110 may be further programmed to store the metrics and risk assessment file 125 in the memory 105, display the metrics, output the risk assessment file 125, etc. Outputting the risk assessment file 125 may include electronically transmitting the risk assessment file 125 via a wired or wireless network, storing the risk assessment file 125 to a memory storage device (such as a flash drive) connected to the computer 100, etc.

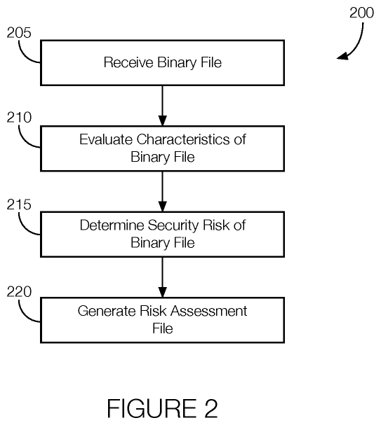

FIG. 2 is a flowchart of an example process 200 that may be implemented by one or more components of the computer 100 of FIG. 1. The process 200 may begin any time the computer 100 is operating and ready to process a binary file 115.

At block 205, the computer 100 receives the binary file 115. As explained above, the binary file 115 is a computer-readable file including data. The binary file 115 is created by compiling human-readable computer code, such as computer code written in programming languages such as C, C++, Java, etc., in a computer-readable format. The processor 110 may receive the binary file 115 after it is provided to or generated by the computer 100, and the processor 110 may execute instructions to store the binary file 115 in the memory 105. In some instances, the processor 110 may execute instructions to generate the binary file 115 by, e.g., compiling computer code already stored in the memory 105. In other instances, the binary file 115 may be received at the computer 100 via, e.g., a wired or wireless network, a memory storage device (e.g., a flash drive), etc.

At block 210, the computer 100 evaluates characteristics of the binary file 115. The processor 110 may execute instructions to access the metadata, determine the characteristics of the binary file 115 from the metadata, and evaluate the characteristics of the binary file 115. The processor 110 may access metadata, stored in the memory 105, about the binary file 115. The metadata may include characteristics of the binary file 115 such as the code size of the binary file 115, the amount of data processing involved with the binary file 115, a count of the number of insecure APIs used in the binary file 115, a count of the number of conditional statements in the code represented by the binary file 115, the cyclomatic complexity of the computer code represented by the binary file 115, etc. In some instances, evaluating the characteristics of the binary file 115 may include the processor 110 executing instructions to determine one or more of the characteristics of the binary file 115 and storing the characteristics as data or metadata in the memory 105.

At block 215, the computer 100 determines a security risk associated with the binary file 115. The processor 110, for instance, may determine the security risk associated with the binary file 115 based on the characteristics, data stored in the CVE database 120, or both. As explained above, the CVE database 120 is a software file including electronic data representing known security vulnerabilities associated with using certain APIs, software libraries, etc. With regard to the characteristics, the processor 110 may be programmed to evaluate the code size, data size, the number of insecure application programming interfaces (APIs), the number of conditional statements, and the cyclomatic complexity of the binary file 115. As previously discussed, a large code size has a larger attack surface, which suggests a higher likelihood of a security vulnerability. For data size, the number of constants and variables referenced by a function can indicate how much data processing will take place. More data processing may indicate greater exposure to security risks. The number of insecure APIs can indicate the risk for vulnerability based on, e.g., the number of processing strings, memory usage, and inputs/outputs used by the insecure API. Insight into the number of conditions or decisions that are being made can also indicate the security risk since, e.g., more conditions or decisions can indicate a higher security risk. Moreover, because cyclomatic complexity is a quantitative software metric that can be used to indicate the complexity of a program based on, e.g., the number of linearly independent paths through a program's source code, a greater cyclomatic complexity can represent a greater likelihood of a security vulnerability in a binary file 115. The processor 110 may consider these characteristics and the data stored in the CVE database 120 to determine the vulnerability of the binary file 115 to a security risk.

At block 220, the computer 100 generates the risk assessment file 125. The risk assessment file 125 is a software file that includes data representing metrics associated with the security risk posed by the binary file 115. The processor 110 may generate the risk assessment file 125 according to the security risk posed by the binary file 115 in view of the characteristics, the data from the CVE database 120, or a combination of both. That is, the processor 110 may determine metrics defining how vulnerable the binary file 115 is to a security threat. The processor 110 may generate the risk assessment file 125 to reflect the metrics, the vulnerability of the binary file 115 to a security threat, or both. Further, in some instances, generating the risk assessment file 125 may include the processor 110 storing the metrics and risk assessment file 125 in the memory 105, displaying the metrics, outputting the risk assessment file 125, etc. Outputting the risk assessment file 125 may include the processor 110 executing instructions to electronically transmit the risk assessment file 125 via a wired or wireless network, store the risk assessment file 125 to a memory storage device (such as a flash drive) connected to the computer 100, etc.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the OS X, macOS, and iOS operating systems distributed by Apple Inc. of Cupertino, Calif., the BlackBerry OS operating system distributed by Blackberry, Ltd. of Waterloo, Canada, and the Android operating system developed by Google, Inc. and the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computer comprising:
a memory; and
a processor programmed to execute instructions stored in the memory, the instructions including processing a binary file to determine a security risk associated with the binary file, wherein processing the binary file includes determining a characteristic from metadata of the binary file and wherein the security risk associated with the binary file is based at least in part on the characteristic of the binary file.

2. The computer of claim 1, wherein the characteristic includes a code size of the binary file, and wherein the processor is programmed to determine the security risk based at least in part on the code size of the binary file.

3. The computer of claim 1, wherein the characteristic includes a data size representing an amount of data processing involved with the binary file, and wherein the processor is programmed to determine the security risk based at least in part on the data size of the binary file.

4. The computer of claim 1, wherein the characteristic represents a count of a number of insecure application programming interfaces are used by the binary file, and wherein the processor is programmed to determine the security risk based at least in part on the number of insecure application programming interfaces used by the binary file.

5. The computer of claim 1, wherein the characteristic includes a count of a number of conditional statements executed by computer code represented by the binary file, and wherein the processor is programmed to determine the security risk based at least in part on the number of conditional statements.

6. The computer of claim 1, wherein the characteristic includes a cyclomatic complexity of computer code represented by the binary file, and wherein the processor is programmed to determine the security risk based at least in part on the cyclomatic complexity of the binary file.

7. The computer of claim 1, wherein the instructions include compiling computer code to generate the binary file from the computer code.

8. The computer of claim 1, wherein the instructions further include receiving data from a common vulnerability exposure database, and wherein determining the security risk associated with the binary file includes determining the security risk based at least in part on the data received from the common vulnerability exposure database.

9. The computer of claim 1, wherein the instructions further include generating a risk assessment file representing the security risk of the binary file.

10. The computer of claim 9, wherein the instructions further include developing metrics associated with the security risk of the binary file, and wherein the risk assessment file includes the metrics.

11. A method comprising:
processing a binary file to determine a characteristic of the binary file; and
determining a security risk associated with the binary file based at least in part on the characteristic of the binary file.

12. The method of claim 11, wherein the characteristic includes a code size of the binary file, and wherein the security risk is based at least in part on the code size of the binary file.

13. The method of claim 11, wherein the characteristic includes a data size representing an amount of data processing involved with the binary file, and wherein the security risk is based at least in part on the data size of the binary file.

14. The method of claim 11, wherein the characteristic represents a count of a number of insecure application programming interfaces are used by the binary file, and wherein the security risk is based at least in part on the number of insecure application programming interfaces used by the binary file.

15. The method of claim 11, wherein the characteristic includes a count of a number of conditional statements executed by computer code represented by the binary file, and wherein the security risk is based at least in part on the number of conditional statements.

16. The method of claim 11, wherein the characteristic includes a cyclomatic complexity of computer code represented by the binary file, and wherein the security risk is based at least in part on the cyclomatic complexity of the binary file.

17. The method of claim 11, further comprising:
receiving computer code; and
compiling the computer code to generate the binary file.

18. The method of claim 11, further comprising receiving data from a common vulnerability exposure database, and wherein determining the security risk associated with the binary file includes determining the security risk based at least in part on the data received from the common vulnerability exposure database.

19. The method of claim 11, further comprising generating a risk assessment file representing the security risk of the binary file.

20. The method of claim 19, further comprising developing metrics associated with the security risk of the binary file, and wherein generating the risk assessment file includes generating the risk assessment file to include the metrics.
